(19) United States
(12) Patent Application Publication
(10) Pub. No.: US 2007/0250470 A1
(43) Pub. Date: Oct. 25, 2007

(54) PARALLELIZATION OF LANGUAGE-INTEGRATED COLLECTION OPERATIONS

(75) Inventors: John J. Duffy, Renton, WA (US); Jan S. Gray, Bellevue, WA (US); Christopher W. Brumme, Mercer Island, WA (US); Henricus Johannes Maria Meijer, Mercer Island, WA (US); Jim Larus, Mercer Island, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/379,946

(22) Filed: Apr. 24, 2006

(51) Int. Cl. G06F 17/30

(52) U.S. Cl. 707/2

(57) ABSTRACT

The subject disclosure pertains to implicitly and adaptively parallelizing program language-integrated operations comprising queries and the like. In particular, a parallel execution plan can be generated and/or selected based on static information surrounding operations. The plan can be augmented subsequently or concurrently based on dynamic information concerning the operations, machine topology, utilization, as well as data characteristics, among other things. As a result, sizeable parallel speedup can be obtained upon execution of the plan and evaluation of the operations.

### BACKGROUND

Microprocessors, or central processing units (CPUs), have made significant advances over the past few decades. Advances include improvement in size, speed and computing power. For instance, the number of transistors per square inch of integrated circuits has steadfastly held to Moore's law and at least doubled every eighteen months. Processor speed has also improved dramatically in relation to increased transistors. By way of example, in a single decade microprocessors progressed from including about three million transistors at a clock speed of 60 MHz to one-hundred and twenty-five million transistors operating at 3.6 GHz. Still further yet, the amount of information that can be processed at a single time has been enhanced in particular from an eight bit data width on the earliest processors to the sixty-four bit data width utilized by present day CPUs.

While processor manufactures have made tremendous advances in computing power, it is widely recognized that advances with respect to the current paradigm are slowing as they approaching an upper bound. More specifically, researchers and manufactures have been focused on advancing sequential speed and capacity via improvements in transistor density, clock speed and data width, among other things. At present, there appears to be a shift in focus toward employing concurrency. In particular, the paradigm is shifting to parallelism via multiple processors or multi-core processors, which combine two or more independent processors in a single integrated circuit package. Such processors can thus provide true hardware-based thread parallelism.

Unfortunately, most existing software is not ready to make use of multiple processors, as it is based on conventional sequential programming languages that only had a single processor in mind. For instance, consider the following exemplary C# code:

```
void ProcessCustomer(Customer c) { /*...*/ }
void ProcessXyzCustomers(List<Customer> customers) {
  DateTime orderDate = DateTime.Now.Subtract(−30);
  foreach (Customer c in customers) {
    if (!c.Active)
      continue;
    if (c.State == “AK” || c.State == “HI”)
      continue;
    bool hasRecentOrder = false;
    foreach (Order o in c.Orders) {
      if (o.OrderDate > orderDate) {
        hasRecentOrder = true;
        break;
      }
    }
    if (!hasRecentOrder)
      continue;
    ProcessCustomer(c); // some lengthy operation
  }
}
```

This code segment would traditionally see a wall-clock speedup when run on new machines and chipsets that exhibit faster sequential execution capabilities as a result of increasing clock speeds. We have enjoyed a continuous growth in clock speed over the decades, leading to an implicit reliance on this phenomenon. As noted above, this trend has already begun to slow, and it will continue to do so over time. The code above unfortunately does not understand that, when run on a machine with multiple hardware threads, it could achieve similar, perhaps greater, speedup by spawning multiple concurrent work items.

This could be done manually, of course, for example by using explicit threading mechanisms that platforms provide for users today as follows:

```
int dop = /*...*/; // degree-of-parallelism
void ProcessCustomer(Customer c) { /*...*/ }
void ProcessXyzCustomers(List<Customer> customers) {
  int chunkSize = Math.Ceiling(
    (float)customers.Count / dop);
  ManualResetEvent[ ] are = new ManualResetEvent[dop − 1];
  for (int i = 0; i < are.Length; i++)
    are[i] = new AutoResetEvent(false);
  for (int i= 1; i < dop; i++) {
    int _{——}i = i;
    ThreadPool.QueueUserWorkItem(delegate {
      for (int j = chunkSize * i,
          c = chunkSize * (j + 1);
          j < c && j < customers.Count;
          j++) {
        Customer c = customers[j];
        if (FilterCustomer(c))
          ProcessCustomer(c);
      }
      are[_{——}i − 1].Set( );
    });
  }
  for (int j = 0; j < chunkSize; j++)
  {
    Customer c = customers[j];
    if (FilterCustomer(c))
      ProcessCustomer(c);
  }
  WaitHandle.WaitAll(are);
}
bool FilterCustomer(Customer c) {
  DateTime orderDate = DateTime.Now.Subtract(−30);
  if (!c.Active)
    continue;
  if (c.State == “AK” || c.State == “HI”)
    continue;
  bool hasRecentOrder = false;
  foreach (Order o in c.Orders) {
    if (o.OrderDate > orderDate) {
      hasRecentOrder = true;
      break;
    }
  }
  if (!hasRecentOrder)
    continue;
}
```

However, this code has become quite a bit more complex than the original code. Furthermore, some of the heuristics are not quite intelligent. For example, it is not straightforward at all to determine how best to arrive at the correct value of “dop” (i.e., degree of parallelism), nor can it even be done statically, and it will most certainly differ based on the machine topology. Additionally, partitioning the data set into as many independent threads might not be the right approach when working with smaller lists of data and less complex processing functions. Accordingly, it is unlikely that users will write code that effectively utilizes the hardware available to them.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject innovation pertains to concurrent execution of collection operations such as queries. The innovation enables wall-clock speedups of programs via implicit adaptive (e.g., automatic, automatically self-tuning) parallel execution on parallel platforms of today and the future. Simple and complex cost-based heuristics can also be employed to facilitate partitioning of data in an efficient manner based on an underlying computer's topology (e.g., processor, cache . . . ). Furthermore, varied styles of parallel execution strategies can be utilized (e.g., horizontal partitioning-based, vertical pipeline-based . . . ) to achieve the greatest possible parallel speedup without sacrificing implied ordering (e.g., sorts) and without introducing contention for shared memory, among other things, which can lead to incorrect results.

In accordance with an aspect of the subject innovation, a component is provided that can generate or identify a parallel execution plan for a particular query or other set of operations. More specifically, the plan component can examine operations (e.g., cost, selectivity, category, ordering . . . ), the environment (e.g., machine topology, utilization . . . ), and/or related data (e.g. format, structure, shape, properties, size . . . ), and automatically select or generate an intelligent plan that optimizes execution of language-integrated operations such as query operations. An execution engine can subsequently execute code in accordance with the plan to facilitate optimized evaluation on a particular machine. Additional aspects of the innovation pertain to refining the plan in light of previous runs to facilitate further optimization, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that optimizes language-integrated collection operations.

FIG. 2 is a block diagram of a plan component.

FIG. 3 is a block diagram of an exemplary generation component.

FIG. 4a illustrates parallel query categories for classification of query operations.

FIG. 4b illustrates an exemplary query composition utilizing the query categories.

FIG. 5 is an exemplary query tree with parallel operation groupings.

FIG. 6 is a block diagram of an augmentation component that facilitates rebalancing of a parallel execution plan.

FIG. 7 is a block diagram of an optimization system including an execution analysis component.

FIG. 8 is a flow chart diagram of a method for executing language-integrated operations.

FIG. 9 is a flow chart diagram of a method of parallel plan generation.

FIG. 10 is a flow chart diagram of a method of plan adaptation.

FIG. 11 is a block diagram that depicts three high-level parallel execution techniques for query operations.

FIG. 12 is a block diagram that illustrates a perfectly parallelizable query executed on a four CPU machine.

FIG. 13 is a block diagram that depicts parallel merge-sort using four CPUs.

FIG. 14 is a block diagram that illustrates a parallel hash-join maintaining inter-operator parallelism throughout the entire tree.

FIG. 15 is a schematic block diagram illustrating a suitable operating environment for aspects of the subject innovation.

FIG. 16 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

As used in this application, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Artificial intelligence based systems (e.g. explicitly and/or implicitly trained classifiers) can be employed in connection with performing inference and/or probabilistic determinations and/or statistical-based determinations as in accordance with one or more aspects of the subject innovation as described hereinafter. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus, or article of manufacture using standard programming and/or engineering techniques to produce software, firmware, hardware or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g. hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Further yet, while the innovation is for the most part described specifically with respect to language-integrated queries, it should be appreciated that the innovation is not so limited. Language integrated operations of any kind such as collection or bulk operations can be parallelized in a like manner as will be appreciated by those of skill in the art. By way of example and not limitation, collection or bulk operations can include operations that are not strictly queries but are associated there with including but not limited to maps and reductions.

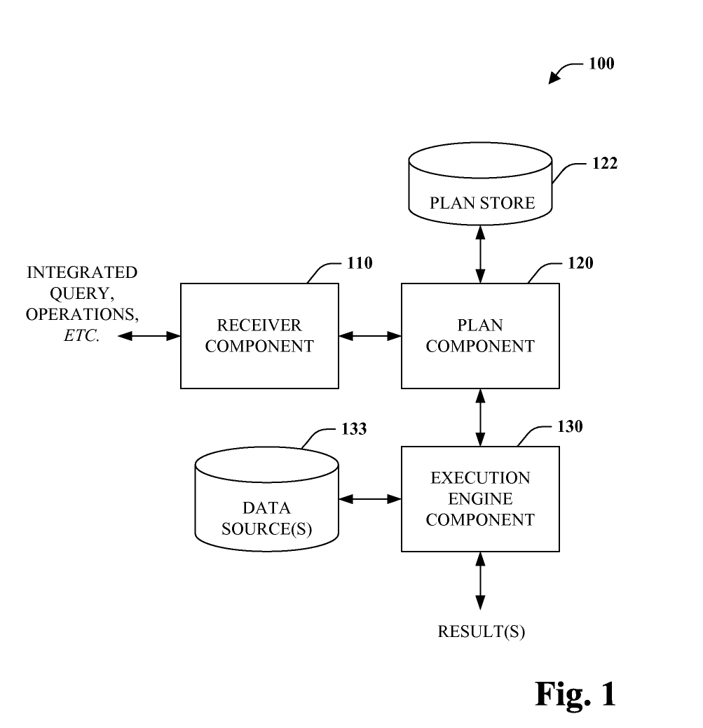

Referring initially to FIG. 1, a system 100 is depicted that optimizes execution of language-integrated collection operations in accordance with an aspect of the innovation. The system includes receiver component 110, plan component 120, plan store 122, execution engine component 130 and data source(s) 133. The receiver component 110 receives, retrieves or otherwise obtains or acquires a set of one or more language-integrated operations and makes them available for use by the plan component 120. It should be appreciated that in accordance with an aspect of the innovation, the set of operations can define a query. A language integrated query or LINQ query can be expressed by a programmer, for example, as a set of one or more operations over a one or more homogeneous or heterogeneous data sources 133. Furthermore, the query/operations can be specified declaratively within an imperative language such that more is said about what the code is to do rather than how it is to be done (e.g., SQL-like fashion). The following code segment illustrates an exemplary LINQ query that retrieves a set of customers from a list, using the criteria that they live in Boston, Mass. and have ordered in the last ninety days. The code then enumerates the results, giving each customer a discount based on the number of times they have ordered.

```
void f(List<Customer> custs) {
  // Query part:
  var results = from c in custs
  where c.State == “MA” &&
    c.City == “Boston” &&
    c.LastOrderDate >
    DateTime.Now.AddDays(−90)
  orderby c.LastOrderDate descending
  select new {
    c.Salutation, c.LastName,
    c.LastOrderDate, c.OrderCount,
    c.Discounts
  };
  // Per-element action:
  foreach (var c in results) {
  Discount d = new Discount(...,
    c.TotalOrderCount * 5.00m);
  c.Discounts.Add(d);
  }
}
```

Upon receipt or retrieval of a LINQ query, the plan component 120 generates a parallel execution plan. The plan component 120 can construct a plan that analyzes and captures information about the overall structure of the query, dependencies between operations and relevant static costs, among other things. The plan then records the relative parallelism and flow of information between operations, which can then later be combined with dynamic runtime information to decide on an appropriate strategy for introducing parallelism. As an optimization, planning can occur by running a binary through a separate planning utility to avoid generating a plan at runtime that depends only on static information. In the case where this optimization is not performed, the plan can be created lazily at runtime.

Plans store 122 can be employed by the plan component 120 to facilitate plan interaction. For example, a plan constructed by plan component 120 can be cached or persisted to store 122 for the next execution. Further, the plan may be modified based on dynamic information acquired during runtime, amongst other things to further optimize query execution. Additionally or alternatively, it should be appreciated that the plan component 120 could select a plan from one or more plans generated and/or housed in store 133 based on context, environmental factors and the like, rather than generating a plan anew.

The execution component 130 executes the plan with respect to one or more like or heterogeneous data stores 133. Such data stores can be in memory or outside of memory. Accordingly, the innovation can operate with respect to an arbitrary graph of objects. Among other things, the execution component 130 is concerned with introducing parallelism, dynamically load balancing, achieving good temporal and spatial locality given a source and synchronizing where necessary in accordance with the plan. Plan execution results in operator evaluation. Hence, the execution component 130 can output query results where the one or more operators define a query.

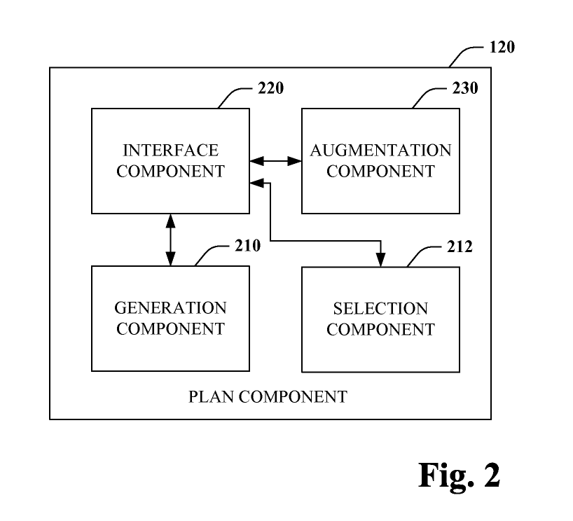

FIG. 2 illustrates a plan component 120 in further detail in accordance with an aspect of the subject innovation. The plan component 120 includes a generation component 210 that can generate a parallel execution plan based on static and/or other information. The generation component 210 is communicatively coupled to the interface component 220 that facilitates communication with a plan store. As a result, generated plans can be persisted to cache or a store after generation via component 210. Additionally or alternatively, plan component 120 includes a selection component 212 that can select amongst a set of stored plans utilizing the interface component 120, which can facilitate communication between the selection component 212 and cache and/or non-volatile stores. When generating or selecting a query plan, the components 210 and 212, respectively, can determine the feasibility and/or fruitfulness of parallelization, for example by weighing costs of introducing parallelism (e.g., spawning new threads, rendezvousing, splitting and merging data . . . and determining benefits given the nature of the query, inter alia.

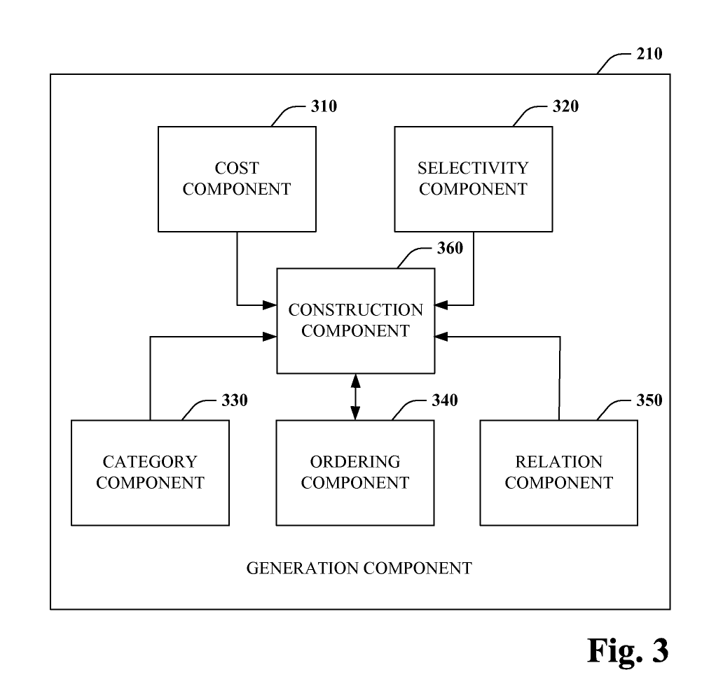

Turning briefly to FIG. 3 a generation component 210 is depicted in further detail in accordance with an aspect of the innovation. The generation component 210 includes cost component 310, selectivity component 320, category component 330, ordering component 340, relation component 350 and construction component 360. Each of components 310-350 are operable to receive, retrieve or otherwise obtain statically knowable or otherwise obtained information. This information can then be provided to construction component 360, which utilizes the information to construct a parallel execution plan.

The cost component 310 determines the cost in terms of time associated with query operations. A costing function can be utilized by component 310 to determine the cost (e.g., static cost) of executing an operation. Adaptive techniques can also be employed to fine-tune the cost over time.

The selectivity component 320 determines the anticipated selectivity (or decay rate) for items passing through an operation. In the case of filters, clearly only a certain number of elements will satisfy the predicate; usually, but not always, this is less than 100% of the total number of items evaluated. Although this may be difficult to determine at first, a fixed number such as 50% can be initially selected and adaptive feedback utilized to make this determination more accurate with time. Assuming an even distribution among queries in terms of selectivity, choosing 50% reduces the chance of worst-case scenarios, where either 0% or 100% are seen dynamically. This figure is used to model the flow of data through the query. The input size for the operation immediately following the filter can be selectivity multiplied by the input size of the operation preceding the filter.

The category component 330 identifies categories of operations based on their input and output data requirements. Certain categories of operations require that all input data be available before producing a single output item, this situation is termed input-bound. Input-bound operations are important because they are used to isolated groups of operations into parallel regions, from the bottom up. Without knowing about this behavior, sufficient parallelism may not be introduced into the query, or conversely excessive parallelism may be introduced where the query ends up waiting for other work to complete. Other operations place restrictions on what can be done with the output for the duration of the query. A sort, for instance, mandates that further operations treat the data stream specially so as not to disrupt the ordering. This can be referred to as an ordered operation. Such an operation places the burden of keeping data sorted on all steps that occur after it.

The order component 340 identifies order requirements for query operations. By way of example, a sort operation necessarily adds a bottleneck to a query. Ideally, a sort is able to generate items for consumption as fast as they are generated by the steps before it. Otherwise, items will clogged up the query's execution, negatively impacting the working set of the application, and diminishing any wall-clock speed up that would have been otherwise possible. Reordering the query can help to avoid this by distributing split and merge operations evenly across an entire query. If the sort is relatively quick, say 10% of the query cost, sandwiching it between two operations, each 45% of the query's execution time, will lead to the greatest speed up.

The relation component 450 identifies the next operation that occurs immediately after the current one in an overall query tree, for example. Each node in the tree normally has only one child. However, a node that performs a join operation between two queries appears as a binary tree node. Notice that this tree is generated in a root-first fashion during query planning and optimization. The tree is actually executed from the leaves at runtime, as the data sources are found at individual leaves in the tree, and the consumer at the root.

In accordance with one particular implementation of the subject innovation, information received, retrieved or determined by components 310-350 can be stored in a QueryStepInfo data structure. An exemplary QueryStepInfo data structure is illustrated below:

```
struct QueryStepInfo {
  int PerCost;
  float Selectivity;
  QueryCategory Category;
  QueryOrdering Ordering;
  IEnumerable<QueryStepInfo> Children;
}
enum QueryCategory {
  MapFilter,
  FullOrPartialReduction,
  Sort,
  Join
}
[Flags]
enum QueryStepOrdering {
  InputBound,
  Ordered
}
```

Given such information, the construction component 360 can calculate a parallel execution plan. The component 360 can calculate each parallel grouping of operations that have no input requirements and the same ordering requirements. This could be the entire query, for example in a case of a simple query that has no operations with either requirement, such as a select/where query. Furthermore, based on such information the construction component 360 can identify parallelization strategies that optimize execution of parallel groups, as described further infra.

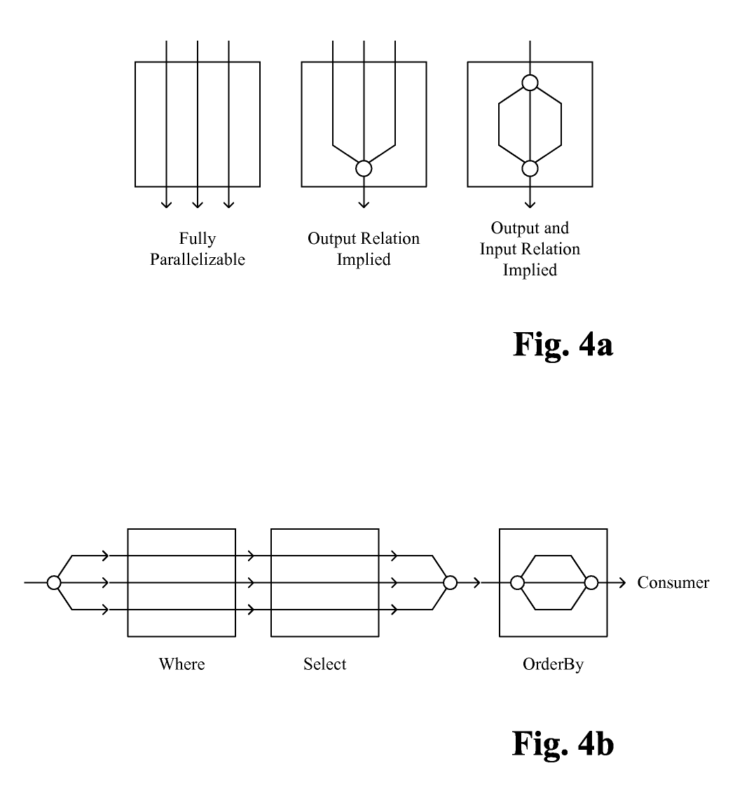

In a simple scenario, parallelization of queries works by categorizing specific operations into one of three buckets. These are graphically depicted in FIG. 4a. The execution of each operation inside a query composes with other operations based on each operation's category. Fully parallelizable operations may execute on partitioned data flowing into and out of the operation. Output relation implied requires that output be coalesced in some fashion before passing it to a consumer. Lastly, output and input relation implied requires that both input and output be coalesced. With each, the opportunity for parallelization and the impact on the overall parallel execution of the query decreases. Clearly chaining together a set of fully parallelizable operations permits complete parallelization, and could easily lead to a super-linear scale-up as a result of intelligently partitioning data to fit within a processor's secondary cache, for instance. Of course, each operation may be parallelized local to itself, for example, a parallel sort, which happens to fall into the output and input relation implied category—to reduce the impact of a coalesce bottleneck.

When a query is composed using the categorization symbols it becomes clearer how a query can be parallelized. For example, consider FIG. 4b, which has been rotated ninety degrees for formatting purposes. This query can be processed in a number of ways. The generation component 210 may choose to execute a query in parallel via use of data partitioning or horizontal parallelism. This is visible at the beginning where a split operation occurs, spawning a number of threads each of which operate over some subset of input data. The exact number of partitions can be determined by the cost of filtering (Where) and projection (Select), among other things (e.g., data structure, data size, machine topology, idle computational resources available, heuristic budgets . . . ), as will be described in further detail below. Each thread then flows execution across the Where and Select operators in parallel with respect to other threads. The merge operator is encountered. Ideally, each of the partition threads will reach this point simultaneously to alleviate the impact of a Merge. In the case that they do not, resources will have to be redistributed to combat data skew. It is to be appreciated that other strategies are also possible. Each operation may be run in parallel with the other, called pipelining. In other words, Where is processing data while Select is simultaneously processing the output of the Where. Additionally or alternatively, a mixture of partitioning and pipelining can be employed to achieve significant speedup.

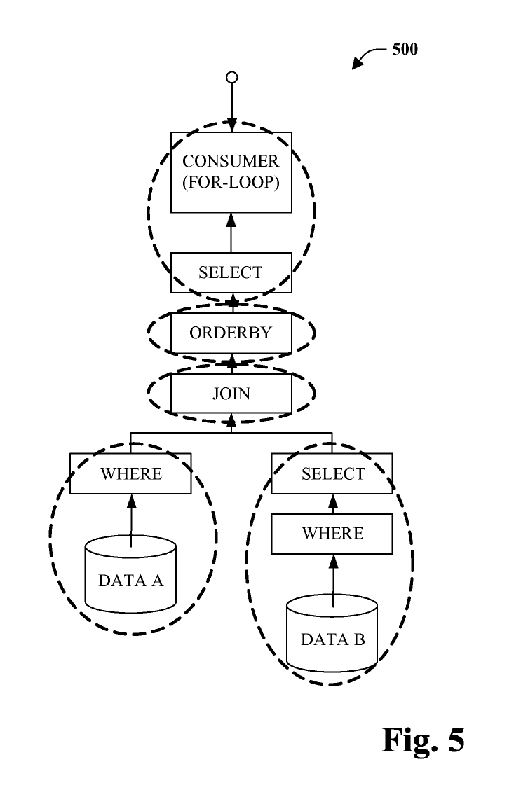

Let us consider a slightly more complex example. Turning to FIG. 5, an exemplary query tree 500 is depicted. The tree 500 represents a query plan for a query that joins two data sources. The dotted circles in the diagram indicated the different parallel groupings in the tree. The top-most group is present in the case of forall consumers. In other words, the user supplied consumption code is considered part of the query when it is to be executed in parallel. For queries that use sort operations, for example, it is unlikely that a user would employ such a loop, since this completely destroys the ordering that the sort creates among the data elements. Notice also that the only place where a single node may have multiple children is during a join. Bushy trees are utilized in the plan representation. Note also that, while internal operations may exhibit parallel structures that can be modeled as DAGs, the higher level query operations are modeled as a tree.

Each parallel grouping is subsequently analyzed to determine the most efficient parallelization strategy. The goal is to calculate the proper amount of parallelism for each group with respect to one another, and to decide on a mixture of parallelism techniques. In the example tree, we wish to ensure that individual elements are produced as fast as possible, such that the consumer may inspect each result with minimal query processing overhead.

Two primary styles of parallelism are used by the construction component 360, labeled inter- and intra-operator parallelism. Intra-operator parallelism executes a single operation in parallel by splitting the work and assigning it multiple CPUs. Inter-operator parallelism, sometimes called vertical parallelism, occurs by executing multiple stages of the query in parallel, each stage of which is given a portion of the available CPUs. This is typically done via pipelining, where stages running on separate CPUs communicate with each other by passing data along to the next stage in the pipeline. Intra-operator parallelism, often called horizontal parallelism, typically takes the general form of partitioning input data, and can actually span an entire grouping. Some operators, like sorts, perform intra-operator parallelism as an internal function, and do not support spanning an entire group. This is referred to as inner parallelism hereinafter in order to distinguish it from partition-based parallelism.

No one technique is perfect for all queries; a combination of each of these strategies can be employed, based on the type of operation and the shape of the query tree. This will be described further in a later section.

The output of the planning phase is a query plan or Queryplan object, which can be used during rebalancing and execution to achieve parallelism. It can include a tree of actions or QueryActions, which map directly to QueryStepInfos. Each action identifies the parallel grouping boundaries and instructs where and how to introduce parallelism. It is optionally serialized to disk, to avoid the cost of recalculating each time. An exemplary layout of this data structure implementation is shown below.

```
[Serializable]
class QueryPlan {
  // fields
  Guid PlanUid;
  int InputSize;
  QueryStepInfo RootStep;
  QueryAction ExecuteAction;
  // methods
  void Calculate( );
  void Rebalance(int inputSize);
  void AdaptFeedback(...);
  void Save(string fn);
}
[Serializable]
class QueryStepAction {
  int TotalCost;
  float TotalWeight;
  int HorizontalPartitions;
  bool NewPipelineStage;
}
```

As shown, a plan has a unique identifier to facilitate serialization and lookup of plans. It also has an InputSize field, which is used to adaptively fine-tune the total size of data at runtime. An initial determination is made when the plan is first created. Each time the plan is rebalanced, a dynamic data set size is supplied. The plan can maintain a rolling average of the data set size it has been run over. This information is used when deciding how much parallelism to introduce, and instructs the planner about stages in the query at which it may need to combate data skew, where the data flowing through the query becomes imbalanced over time as a result of selectivity. The RootStep is the root of the query tree and the ExecuteAction is the suggested parallel strategy.

Referring back briefly to FIG. 2, the query plan component 120 also includes an augmentation component 230 that is communicatively coupled to the interface component 220 to facilitate communication with one or more generated and/or saved plans. As will be appreciated, while some information is known in advance, other information is not. The augmentation component 230 can facilitate augmenting or rebalancing a plan at runtime to optimize for common problems. This augmentation can be injected just prior to the execution of each query. Based on measurements, the overhead is minimal and the benefits often outweigh the costs.

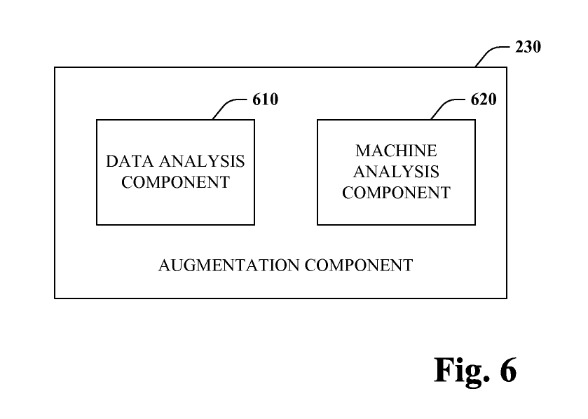

Turning attention to FIG. 6, an augmentation component 230 is illustrated in further detail according to an aspect of the innovation. Component 230 enables augmentation based on dynamic information. It is to be appreciated that this augmentation or rebalancing action need not recalculate the entire plan. Rather the component 230 can simply supply variables to the plan, which may have been generated using ratios, flow information and fuzzy data. Augmentation thereby facilitates making final decisions about how much parallelism to introduce and where. The augmentation component 230 can include a data analysis component 610 and a machine analysis component 620.

The data analysis component 610 can identify data source properties or characteristics that can be utilized to rebalance an execution plan. For instance, if the data structure being queried has a fixed, known size, and the difference between that size and the assumed size, which the plan previously generated, is larger than a default value, portions of the plan can be augmented. Additionally, if a constructed plan chose not to introduce parallelism due to a small-assumed data size, or conversely introduced too much because of a larger assumed size, these decisions can be revisited. Furthermore, note that rebalancing need not be related solely to data size. Other characteristics can also provide a basis for plan augmentation. For example, if a the data analysis component 610 can identify that the data source implements a particular interface or pattern, then the plan may be rebalanced to optimize the query for a particular data structure.

Machine analysis component 620 examines a computing machine to enable optimization to be specifically tailored. For example, machine topology and current utilization can be determined. Such information can be utilized to throttle the amount of parallelism injected, for example, when at least one processor appears to be very busy with work. Just as with the dynamic data size, the augmentation component 230 can enable revisiting decisions made to reduce the total number of CPUs the query will utilize. That is, of course, statistical by nature. The work that caused a processor to be pegged at 100%, for instance, could finish immediately after the plan is augmented. Accordingly, measurements should be taken over large enough sample sizes to determine how profitable, or damaging, these edge cases are to the query's execution. A minor or short-lived spike in CPU utilization could remove a significant degree of parallelism from a long running query, for instance.

Although the data analysis component 610 and the machine analysis component 620 can be significant components with respect to the augmentation component 230, the component is not limited thereto. The augmentation component 230 can include any number of components relating to receipt or retrieval of dynamic runtime information. For example, the augmentation component 610 may also augment a plan based on dynamic context in which the query is being used, for example nested inside another parallel computation.

Further per plan execution and in accordance with one implementation, it is to be noted that a parallel LINQ provider can be implemented as a sequence class. A sequence class offers a single method for each of the supported query operations and can be responsible for producing runtime data structures needed to execute the query.

Each such operation in a parallel LINQ can contruct and return a QueryStep object that abstractly describes the query step's characteristics. It can implement IEnumerable<T> so that it can be used to iterate over items. This QueryStep class is marked as abstract, meaning it cannot be instantiated directly, and has several internal implementations specific to the types of query operations supported (e.g., maps, filters, sorts, reductions). The main structure and supporting types of an exemplary QueryStep object are depicted below.

```
interface IQueryStep<T> {
  void SetContext(QueryContext ctx);
  IEnumerable<T> Prepare( );
  IEnumerable<T> BuildQuery(int idx);
}
abstract class QueryStep<T,S> :
    IEnumerable<S>, IQueryStep<S> {
  // ctor
  QueryStep(QueryStepInfo info,
    IEnumerable<T> src);
  // fields
  IEnumerable<T> src;
  QueryContext ctx;
  QueryStepInfo info;
  bool isPrepared;
  // methods
  void SetContext(QueryContext ctx);
  IEnumerator<S> GetEnumerator( );
  IEnumerable<S> Prepare( );
  IEnumerable<S> BuildQuery(int idx);
  abstract IEnumerable<S> BuildStep(
  QueryStepAction a,
  IEnumerable<T> querySrc);
}
```

The QueryStep can be the entry point to the query. It can lazily construct a plan, if one has not been cached. In any case, it prepares the tree, by modifying various QueryStep objects in the query tree with data from the plan. It can do this in a top-down manner, using a QueryContext object to flow information across nodes in the tree. The end result is a tree of executable objects. These executable objects, much like the QuerySteps themselves, can be simple enumerators. As they are executed, they introduce and orchestrate the parallel operations transparently.

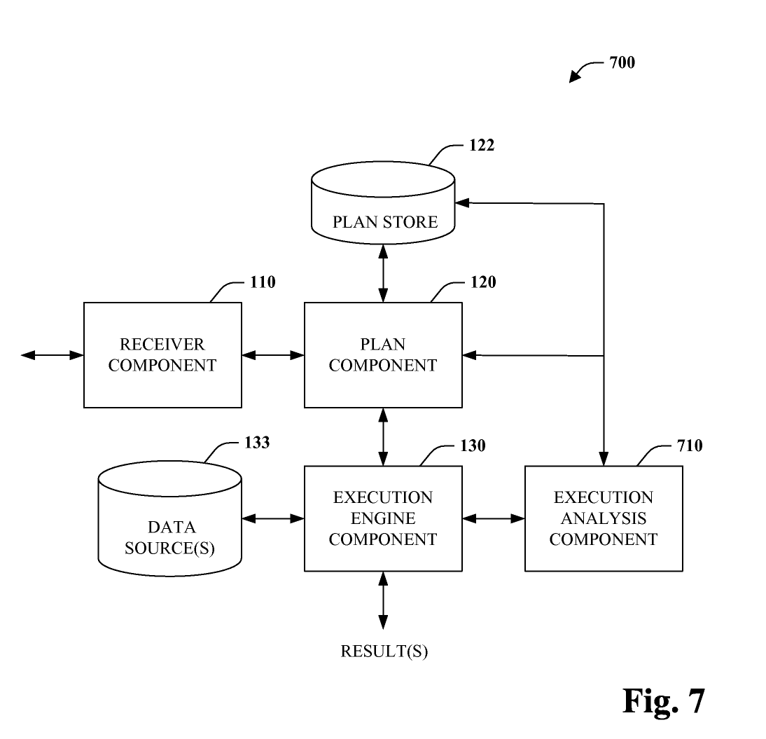

Referring to FIG. 7, an optimization system 700 is illustrated in accordance with an aspect of the subject innovation. Similar to system 100, system 700 includes receiver component 110, query plan component 120, plan store 122, execution component 130 and data source(s) 133. In brief, the receiver component acquires a set of one or more language-integrated operations and provides them to the plan component 120, which can select a parallel execution plan from plan store 122 or newly generate such a plan. This plan is subsequently executed by execution component 130 with respect to one or more data stores 133, for instance. System 700 also includes execution analysis component 710 communicatively coupled to the execution component 130 as well as plan generator 120 and/or plan store 122. The execution analysis component 710 can seek to improve future executions of the plan be feeding back data to the query plan component 120 which can modify the plan in response to provided statistics. Alternatively, the execution evaluation component 710 can modify a cached or stored plan itself to optimize future execution.

The execution analysis component 710 can be especially useful in identifying, and ultimately correcting, data skew. Data skew occurs when partitions end up with unbalanced amounts of data over time. This can lead to a substantial increase in synchronization overhead—due to work stealing; waiting—due to some operators completing before others; and loss of scaling—due to less than perfect utilization of available CPUs, for instance. In an ideal situation, each partition would have the same amount of data at all times. During the actual partitioning itself, the implementation ensures this is the case, but for operations with selectivity (e.g., filters) individual partitions can become imbalanced over time.

As an extreme example of data skew, imagine a query with two partitions, each of which involves a filter. Further, imagine that the data source is 1,000,000 elements. On average, this filter has a selectivity of 50%, meaning that 500,000 elements will be present in the final result-set. Imagine what happens if it the 500,000 elements in partition 1 match the predicate, while the 500,000 elements in partition 2 do not. This is directly in-line with our anticipated and planned selectivity, but leads to a complete imbalance in the partitions. While it is unlikely that this worst-case situation will occur precisely as explained here, it is possible. If the filter is pruning out ranges of elements from a sorted list, it is not too hard to imagine how this might occur. However, minor degrees of variance are very common.

A solution that can be implemented by component 710 to the general problem of skew is to allow parallel units to employ a technique called dynamic work stealing, which is a practice that seeks to dynamically balance the partitions at runtime. When an operation sees that data has been exhausted, it quickly checks to see if all parallel units have completed. If they have not, and if the remaining amount of work to be done is high enough, the stalled operation steals the next n elements from the first available data-source that it finds. The number n is calculated based on the size of the data elements and the underlying data set. This incurs some synchronization and bookkeeping overhead to ensure that parallel workers do not attempt to process the same data concurrently, but experimentation has shown the benefits of dynamic skew balancing to outweigh this cost in severe cases of data skew. The benefits diminish as the skew lessens in severity.

It is also to be appreciated that much of the plan component 120 decisions are based on variables, which are not known statically. This process includes making cost assessments for query operations, data sizes, function calls, and filter selectivities. The planner makes an initial guess based on quick and fast static analysis, but this guess is apt to be incorrect. In some cases, the delta can be minor, but in others the guess can be wildly incorrect. When plans are cached and reused, using adaptive and dynamic metrics to fine-tune the plan over time, based on actual query runs, this can lead to increasingly better plans for each time the query is executed.

In one implementation, the adaptive algorithm employed can be very primitive. By way of example, the algorithm at first can completely throws away its initial guesses after the first run. It can then replace these guesses with actual measurements gathered during the first execution, and recalculates the plan. From that point forward, a simple rolling average can be maintained for the next series of runs, until the rolling average delta between two runs falls below a fixed epsilon.

Of course, the subject innovation also contemplates utilization of more aggressive adaptation techniques. For example, often the variables measured are still subject to vary from one execution to the next. If these bounce from one extreme to the other, using a rolling average will make the query suboptimal for both extremes. Thus, a planer component may choose to generate multiple plans in this case, and select one of many lazily based on some characteristics of the environment at runtime.

The aforementioned systems have been described with respect to interaction between several components. It should be appreciated that such systems and components can include those components or sub-components specified therein, some of the specified components or sub-components, and/or additional components. Sub-components can also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation the execution analysis component 710 could employ such mechanisms to infer and proactively account for imbalance. Further yet, the plan component can employ machine learning and the like to facilitate generation and/or selection of better plans initially.

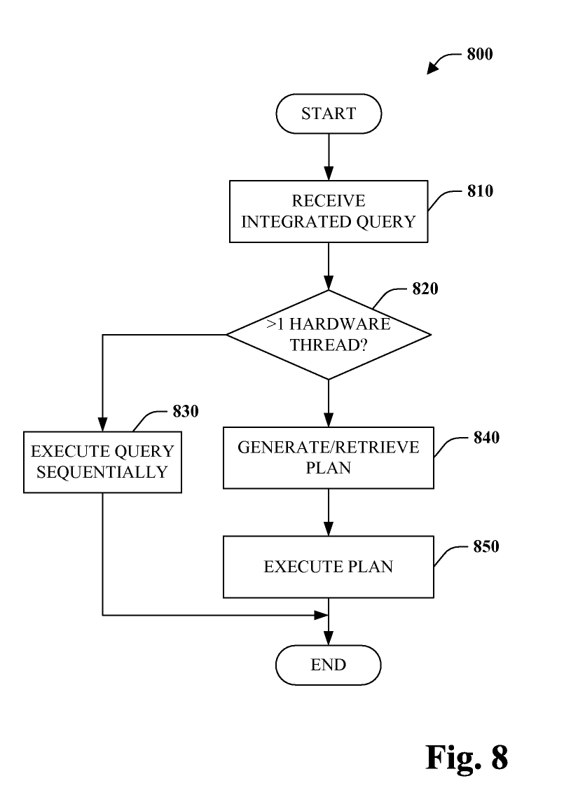

In view of the exemplary systems described supra, methodologies that may be implemented in accordance with the disclosed subject matter will be better appreciated with reference to the flow charts of FIGS. 8-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

Referring to FIG. 8, a method 800 of executing language-integrated operations is illustrated in accordance with an aspect of the subject innovation. At reference numeral 810, a language-integrated operation such as a query (or LINQ query) is received, retrieved or otherwise obtained or acquired. At 820, a determination is made concerning whether the machine hardware supports more than one thread of execution. For example, more then one CPU may be available or a processor can be dual cored, among other things. If the hardware only supports a single thread, the query is simply executed sequentially at 830 and the method terminates. Alternatively, if the hardware supports more than one thread, the method proceeds to reference numeral 840 where a parallel execution plan is generated to optimize execution. This plan can include both static and dynamic information pertaining to the query (e.g., cost, selectivity, category, relationship . . . ), associated data source(s) (e.g., structure, size, shape . . . ), and the executing machine (e.g., topology, hierarchy, utilization . . . ). After the plan is generated, it can be executed at reference numeral 850 thereby evaluating the query in an optimal fashion.

Accordingly, the method 800 facilitates faster query evaluation through a parallel and adaptive strategy that is optimized for the topology of the machine on which the program is run. A wall-clock speed up is often achieved at the expense of a greater number of computations spread across more than one hardware thread. Given some work w, its sequential execution time can be stated by t(w)₁, and its parallel execution time can be stated by t(w)ₚ, where p represents the degree of parallelism (units of concurrent execution). What is sought is a speedup ratio of sp(w)ₚ/t(w)ₚ>1, for some value of p. Furthermore, it should be appreciated that in contrast to conventional parallel programming models, no parallelization directives, pragmas or compiler hints are needed to steer the optimization. The query, its environment and the associated data are analyzed and utilized to create an optimal plan for execution automatically.

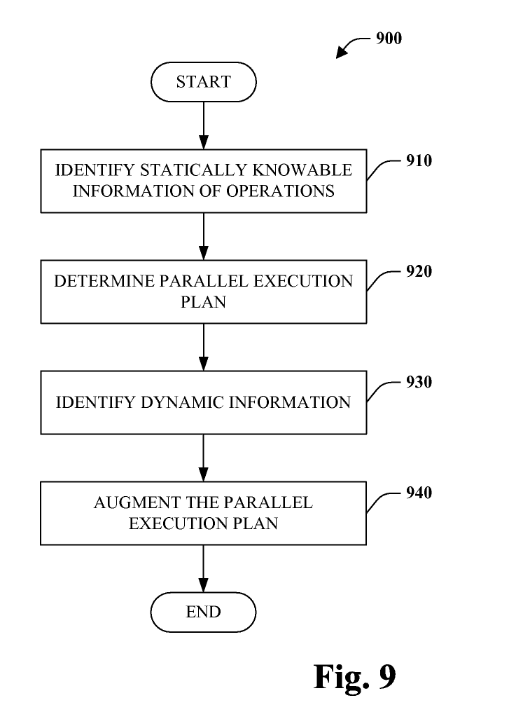

FIG. 9 a method of parallel execution plan generation 900 is depicted in accordance with an aspect of the subject innovation. As previously described, such a plan can be generated automatically in response to the resources of an executing machine to optimize execution of queries and/or associated operations. At reference numeral 910, statically knowable information of operations is identified. This can include information such as the cost, anticipated selectivity, category and ordering of operations, among other things. From this information, a parallel plan can be generated at 920. For example, this plan can be represented as a query tree with identified parallel groupings. Furthermore, the parallel groupings can be associated with the most efficient parallelization strategy (e.g., inter-operator (viz., pipleling . . . ), intra-operator (viz., partitioning . . . ) . . . ). At reference numeral 930, dynamic information is identified, for example at runtime. Such information can include but is not limited to machine topology (e.g., number of CPUs, cache size . . . ), current machine utilization and dynamic context in which the query is being used (e.g. nested inside another parallel computation . . . ). Further, dynamic information can pertain to one or more data sources to be queried. Such information can concern, the size of the source as well as other information including the structure, shape, and/or format of the data. At numeral 940, the parallel execution plan is augmented in view of the dynamic information. In this manner the plan can be tailored to the particular execution environment as well as the data queried, for instance. It is to be noted that while the plan can be created prior to runtime, as it is initially based on static information, the entire plan can alternatively be generated at runtime. Further yet, plans can be saved such that they can be selected and reused in the future. Accordingly, plans need not be generated from scratch if an applicable plan is already available. This can be beneficial, among other things, because a previously generated plan may have been optimized with respect the same machine on which it will be run yet again.

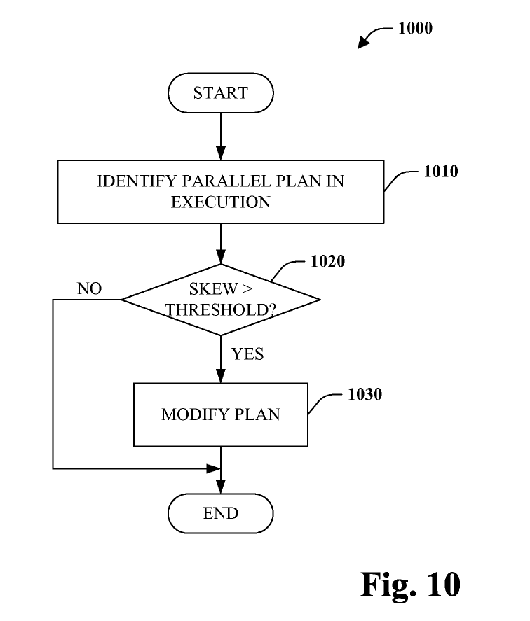

Turning to FIG. 10, plan adaptation method 1000 is illustrated in accordance with an aspect of the innovation. Once a parallel plan is generated and executed, modification of the plan need not cease, especially in light of data skew and the like. As previously mentioned, data skew can occur when partitions end up with unbalanced amounts of data over time. At reference numeral 1010, a parallel plan in execution is identified. At 1020, a determination is made concerning whether data skew is within a threshold. If the skew is not greater than a threshold then the method can simply terminate. Alternatively, if the skew is greater than a threshold, the method can proceed to 1030, where the plan is modified to account for the skew. The plan can be modified so as to affect future executions and/or such modification can be done dynamically such as via dynamic work stealing, among other things.

Partitioning and orchestrating parallel communication among query steps is the primary and most complex task associated with the subject parallel LINQ system. It takes an abstract description of the query, the plan, and makes it happen.

Certain operations limit the degree to which parallelism may be achieved. For example, a sort operation cannot run in parallel with operations “below” it in the tree, because it requires all input before it can make progress. Operations that occur after the sort in the tree, however, can be run in parallel, processing individual items as they become available. On the other hand, such operations could wait entirely for the sort to complete, enabling the sort to use all available parallel processing power for itself, to internally parallelize its own execution. These are examples of the typical decisions and trade-offs the plan component 120 must make to optimize execution.

The query execution seeks to minimize each operator's local execution time, without making one-off decisions that could impact the global execution time. This indeed is one key benefit the system provides—an all-knowing, top-down parallel runtime.

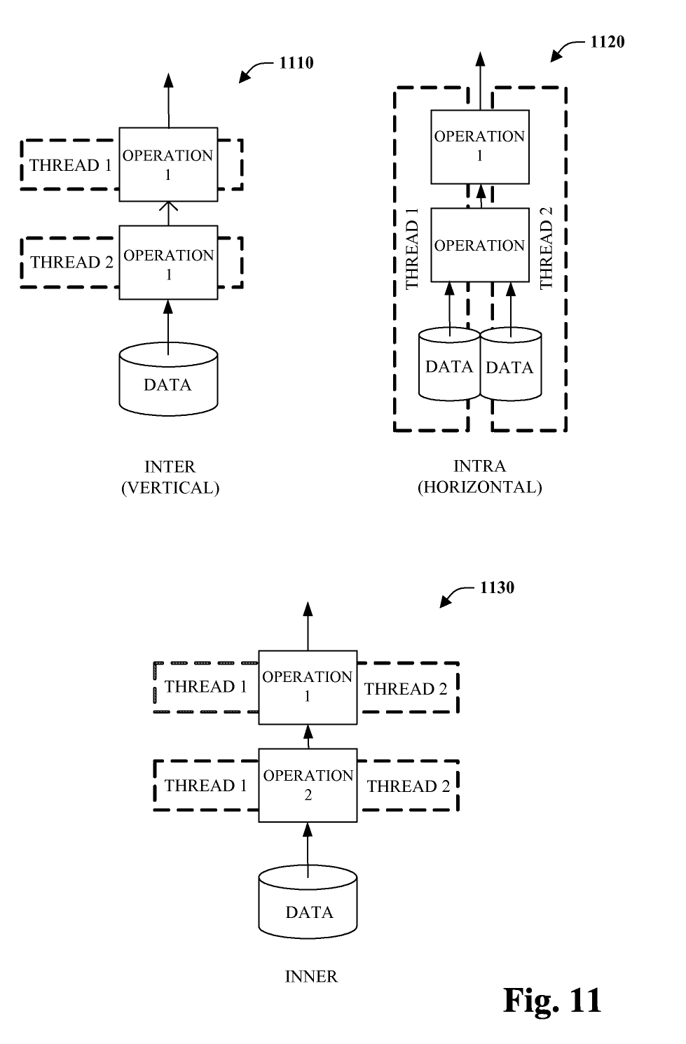

Turning to FIG. 11, three high-level parallel execution techniques 1110, 1120 and 1130 for query operations are illustrated in accordance with an aspect of the subject innovation. The three high-level strategies that can be employed in conjunction with aspects of innovation include intra-, inter-, and inner-operation parallelism, illustrated in FIG. 11. These techniques can be summarized as follows.

Inter-operator parallelism 1110 employs pipelines so that individual stages in the query can execute in parallel with one another. This is often used to balance a query. For example, if a where predicate takes twice the amount of time as the select projection function, it is often profitable to use pipelining: twice the number of threads are dedicated to filtering the data as the select; this ensures that, on average, the projection never has to wait for input from the filter.

Such an operation appears to consume a single stream and produce a single stream. However, the execution engine ensures that the stream executes on its own thread. Producing new items requires synchronization with a consumer, using a blocking queue, which incurs a certain level of overhead. The implementation buffers output elements so as to amortize the cost of synchronization over the lifetime of the query and to align data on CPU cache-line boundaries. An imbalanced query, which utilizes pipelining, however, can exhibit extremely poor performance characteristics. Based experiments, intra-operator parallelism 1120 generally leads to better overall parallel speedup, except for severely imbalanced queries.

Intra-operator parallelism 1120 uses a partitioning strategy to break up the data into multiple streams. Each stream is operated on in parallel, and can be read from independently. This requires a partition step, which splits the data into n streams, where n is determined by the query optimization system; and a merge step, which takes n streams and merges them into one stream. If any operation further down in the tree has imposed ordering requirements on the output, the split/merge operations should preserve this.

An operation that uses partition-based parallelism exposes its streams directly to consumers. This enables another operator, which uses intra-operator parallelism 1120 to read from another operation directly such that it carries parallelism from one operator to the next. Only the first operator to introduce this style of parallelism in one parallel group is required to perform the partitioning function, eliminating unnecessary merges and splits. Merges happen implicitly at the boundary of a parallel group. An interface that can be utilized internally to denote these multi-stream operations is a IMultiStreamOperation. An exemplary implementation of the interface is denoted as follows:

```
interface IMultiStreamOperation<T> :
    IEnumerable<T> {
  int StreamCount { get; }
  IEnumerator<T> GetEnumerator( );
  IEnumerator<T> GetStreamEnumerator(
    int index);
}
```

Internal implementations of this interface, such as PartitionedStream class, know when and how to perform merges and splits. These are data structures the system uses for query execution and preferably do not surface to the end user. When the enumerator is opened, it performs the partitioning. When a consumer invokes the GetEnumerator method, it merges the buffered output, and enables a single-stream view.

An operator that uses internal parallelism 1130 executes in an internally parallel manner, but does not expose this fact to other operations. In other words, it appears to consume and produce a single stream of data, although internally it manages to produce items in a parallel manner. Parallel sorts are a great example, which we examine further infra.

These techniques are not mutually exclusive. In fact, nearly all queries end up using a combination of the three. An individual step itself will often exhibit a combination of these techniques. For example, we can pipeline a single partitioned operation, which has the effect of using Tpartition×Tpipeline threads, where Tpartition is the number of partitions and Tpipeline is the number of pipeline stages. These operations can furthermore employ inner-parallel techniques too, which has the effect of using Tpartition×Tpipeline×Tinner threads, where Tinner is the number of threads utilized for the inner parallelism.

The query planner and execution engine should work in unison to ensure that the number of threads always remains under the number of CPUs on the machine. If this is not achieved, the thread scheduling overhead will impact the realized performance. A plan that over-introduces parallelism can lead to significant degradations, even when compared to straight-line sequential execution.

There are various categories of operations, each category of which can use similar parallelization techniques for all operations that fall into that category. Categories include but are not limited to filters, maps, sorts, reductions (e.g., full and partial), and joins.

A filter is a bulk operation, which takes a collection of items of type T and produces a collection of items of type T, which contains only items from the source data set that matched the filter. The user defines their filter function, which is then executed on each item to determine whether it should appear in the output set.

A map is a bulk operation that takes a collection of items of a certain type T and produces an equal-sized collection of items of another type U. Maps can be represented via projection operations via the select operator. The user defines a function, much like with a filter, which is executed against each item in the data-source in order to produce the mapping output.

Because both mapping and filtering are associative and commutative, they can be easily parallelized using a straightforward intra-operator approach. Ordinarily this takes the form of partitioned parallelism spanning adjacent maps and filters, but pipelining may also be used for adjacent maps and filters with large variances in the execution cost. In one implementation, an object of type QueryMapFilterStep is used to represent such an operation at runtime, which returns an executable structure that implements a IMultiStreamOperation interface.

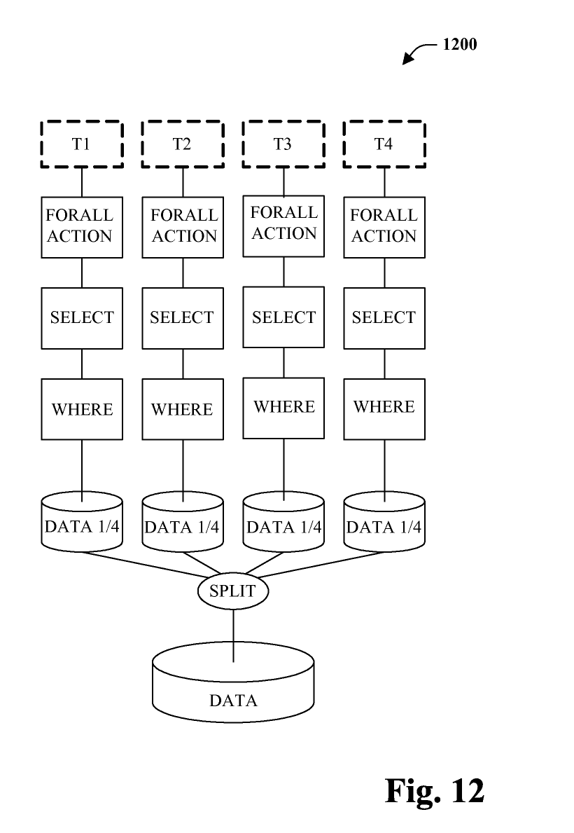

A query that consists of only maps and filters is perfectly parallelizable, leading to a near linear speedup. This is because the entire tree can be partitioned. By way of example, consider the perfectly parallelizable query 1200 of FIG. 12 executed on a four CPU machine. Essentially n copies of the entire query are run in parallel against 1/n^{th} of the data, where n is the number of non-busy CPUs. The actual value of n is determined by the query plan component. The only sequential overhead is the cost of partitioning the data, assigning the partitions to parallel workers, and the synchronization necessary to avoid data skew

Sort operations are unique and present complex challenges in the realm of query parallelization. They are both input-bound and ordered. Furthermore, users will typically consume the results of such an operation using a sequential foreach rather than a parallel forall loop, so as not to disturb the ordering created by the sort operation itself. The result is queries that employ sorting do not parallelize nearly as well as those that do not.

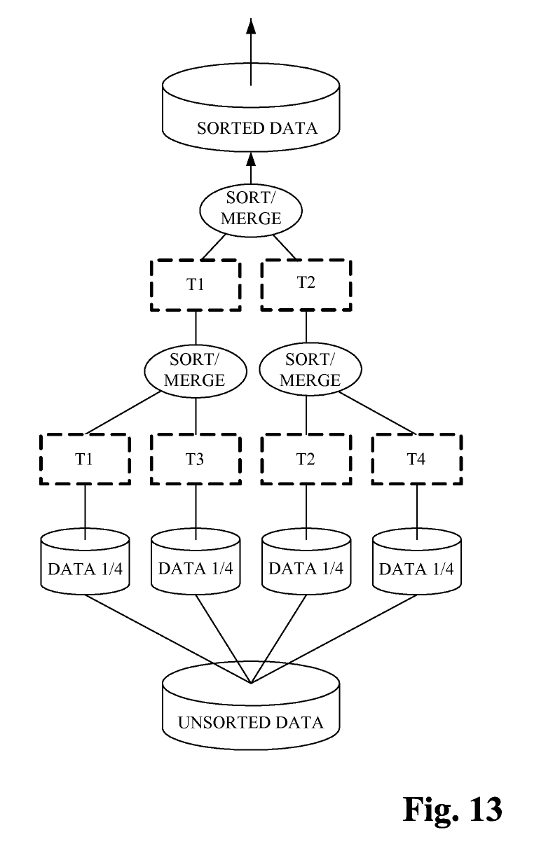

With that said, there is quite a bit of research in the realm of parallel sorts that offer a good analysis of possible techniques. One implementation that can be employed is a simple parallel merge-sort implementation. This overall process is depicted in FIG. 13. The sort operation itself is represented by a special QuerySortStep object, which appears to be a purely sequential enumerator. In other words, it consumes a single data stream and produces a single data stream. Internally, however, it uses the degree of parallelism suggested by the query plan to perform the sort in parallel.

The sort begins by executing the operations below it in the query tree, by calling MoveNext on its child and storing the results into a temporary buffer. In the case where the sort is positioned directly on some native collection data structure, like an array, it employs an optimization to avoid copying this data to temporary storage, instead just operating on the raw data-source itself.

Next, the operation performs a standard parallel merge-sort. It split the input in half, and then it assigns a separate thread to recursively perform the merge-sort on one half, and the calling thread then goes on to recursively perform a merge-sort on the remaining half. Once the available CPUs are taken up, it falls back to a simple sort (e.g., quick sort) on the input data.

Lastly, the operation then merges the individual sorted halves in parallel, to create a single array of sorted output. The merge phase consumes only two CPUs, rather than each of them.

Exemplary pseudo-code for the parallel sort algorithm is shown below. The dop parameter is initialized to log₂(t), where t is the maximum number of threads that the query engine decides the sort should utilized. In cases where the sort does not run in parallel with any other query operation, such as a parallel tree being joined, t will be the number of non-busy CPUs on the machine.

```
IEnumerable<T> Sort<T>(
    T[ ] input, int dop) {
  if (dop == 0) {
    QuickSort(input);
    return;
  }
  // Split input into halves:
  int m = input.Length / 2;
  T[ ] half1 = subarray(input, 0, m);
  T[ ] half2 = subarray(input, m);
  // Assign one half to another
  // thread. Current thread processes
  // the other.
  event sortDone;
  ThreadPool.QueueWork(delegate {
    Sort(half1, dop − 1);
    SetEvent(sortDone);
  });
  Sort(half2, dop − 1);
  WaitEvent(sortDone);
  // Merge the results together:
  T[ ] temp;
  event mergeDone;
  ThreadPool.QueueWork(delegate {
    MergeFromLeft(input, temp);
    SetEvent(mergeDone);
  });
  MergeFromRight(input, temp);
  WaitEvent(mergeDone);
  // Copy the results back:
  temp.CopyTo(input);
}
```

In the end, even with this parallelism, sorts are quite damaging to the overall parallel speedup. They prohibit forall consumption, do not parallelize as cleanly as other operations, and break up runs of adjacent partitioned operations.

Optimizing joins for traditional database queries has been a topic of much research. Here, a simple hash join mechanism can be employed in cases where the elements to be joined support hashing, and one can fall back to a Cartesian join in other cases. For large queries that do not fit into memory, mechanisms can be provided to spill and retrieve parts of the data set to and from disk or other non-volatile store.

The join process works as follows:

Define a function, keySelect, which maps from an element of type T or of type U to type K. This is supplied by the programmer.
There are two input data-sources to consider, one of type T, the other of type U. Select the smaller of the child input streams, S. The larger is called L.
Build a hash-table h consisting of a mapping from keySelect(e) to e, for each element e in S. This is called the building phase. Multiple elements may yield the same key value when passed to keySelect, and thus the hash-table must actually map from keys to a list of elements. This facilitates N−1 and N−M style joins.
For each element e in L, compute its key, via keySelect(e), and look up the corresponding values in h. This produces a set of tuples consisting of the matching elements in h from S and the element e in L. This is called the probing phase. This step produces a list of elements of type U, where U is the result of mapping a user-supplied function over the matching tuple.

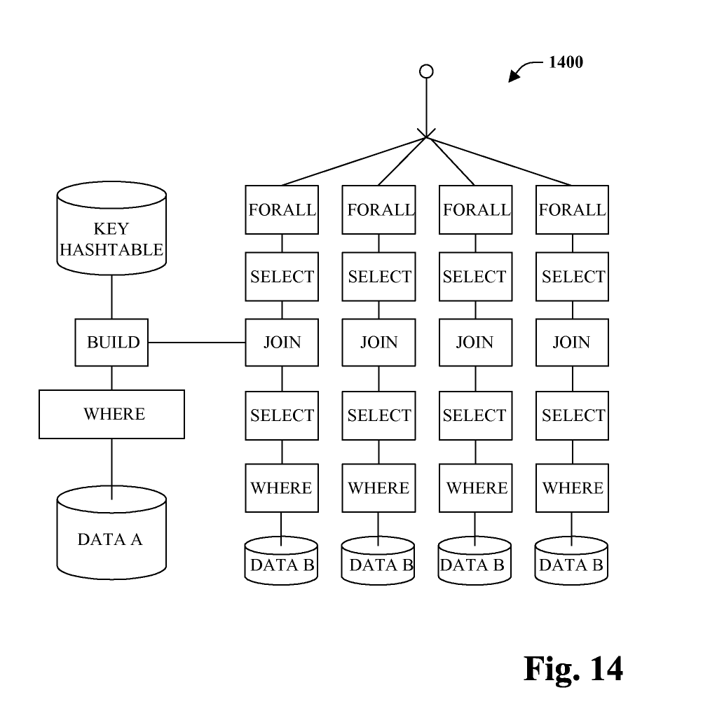

There are several sources of parallelism in this join implementation technique. The building phase can be performed mostly in parallel, much like the reduction operators above. In fact, this phase actually makes use of the Reduce operator internally; individual smaller hash-tables are first generated in parallel as the partial reduction, and then merged into one master hash-table as the full reduction step. The probing phase can also execute in parallel, via standard partitioning or pipelining. A join is only input-bound on the full data from the smaller data set, which it needs to generate the hash-table. Aside from that, if the larger data set is a partitioned data stream, it can flow through the join operator, keeping its partitioned shape. This is shown in FIG. 14.

As illustrated in FIG. 14, building the key hash-table can be done in parallel with respect to the entire tree, at least because all four copies of the join depend on the shared hash-table. Aside from that single point in the execution of the query, the remainder executes using the traditional intra- and inter-operator parallelism described above. What follows is exemplary pseudo-code for this join algorithm.

```
class Hash<K,T> :
  Dictionary<K,List<T>> { ... }
IEnumerable<U> Join<T,S,K,U>(
  IEnumerable<T> left,
  IEnumerable<S> right,
  Func<T,K> leftKeySel,
  Func<S,K> rightKeySel,
  Func<T,S,U> map) {
  // The intermediary hash step:
  Func<IEnumerable<T>,
    Hash<K,T>> intermediate =
  delegate(IEnumerable<T> s) {
    Hash<K,T> d = Hash<K,T>( );
    foreach (T t in s) {
    K k = leftKeySel(t);
    List<T> val;
    if (!d.TryGetValue(
      k, out val)) {
      val = new List<T>( );
      d.Add(k, val);
    }
    val.Add(t);
    }
  };
  // The final reduction step:
  Func<IEnumerable<Hash<K,T>>,
    Hash<K,T>> final =
  delegate(IEnumerable<Hash<K,T>> s) {
    Hash<K,T> d = new Hash<K,T>( );
    foreach (Hash<K,T> h in s) {
    foreach (Pair<K, List<T>> kv
      in h) {
      List<T> val;
      if (!d.TryGetValue(
        kv.Key, out val))
      d.Add(kv.Key, kv.Value);
      else
      foreach (T t in val)
        val.Add(t);
    }
    }
  };
  // Build:
  Hash<K,T> hash = Reduce<T, S, U>(
    Partition(leftSource),
    Intermediate, final);
  // Probe:
  // Return an enumerator that
  // partitions the right, and uses
  // streams to return the results...
  }
}
```

It is to be noted that the subject parallel query system and aspects thereof can take into account not just the number of CPUs available, but the type of CPU and cache hierarchy used. Locality of reference is considered when partitioning and pipelining query operations.

Temporal locality is improved when pipelining multiple operations via specialized knowledge of the cache hierarchy layout. When running on a NUMA or multi-core machine, which share single caches among more than one PU, the scheduler prefers to place two adjacent stages in a pipeline onto PUs such that they share the cache. The buffers used to hand off data between stages are sized to be a multiple of the cache line size, to avoid cache line ping-pong.

Spatial locality is improved during partitioning by placing contiguous elements in a data-source together. Further merge and partition operations attempt to keep elements as close together as possible, so as to maintain this locality benefit. Note that this is merely a heuristic, and is not foolproof—adjacent elements in a data-source does not necessarily imply spatial locality.

User-supplied functions are free to utilize writable, shared data, which can lead to cache impacts during partition-based scheduling. (Code is not a problem in this regard, as it is assumed to be read-only.) Furthermore, functions for separate operations in the query can share data, which can similarly lead to cache problems in a pipeline scenario.

It is to be noted that one programming model problem that quickly arises is that of data dependence and function impurity—that is, functions, which modify state rather than just compute a result based on input. There are no type system or language restrictions to prevent the programmer from writing (1) a query consisting of impure predicates, projections, etc. and (2) per-element actions which require a specific ordering, whether as a result of data dependence or intimate knowledge of the action's effects. Blindly executing such things in parallel could be disastrous for categories of operations, silently introducing race conditions and other related bugs.

These represent difficult-to-solve, yet very real problems. Two observations are offered: First, most user-written query functions are in fact pure. The declarative and side-effect-free nature of SQL queries brings along many preconceived notions. The developer who is familiar with database programming tends not to write predicates that mutate state or perform complex IO, for example. Thus, it can be left to developer discipline to avoid this problem once she decides to import a parallel LINQ query library into individual source files.

Second, it is much more common for the per-result action to rely on some form of shared state. This action is usually represented using a foreach statement (in C#), whose body can be of arbitrary length and complexity. The default execution model for parallel LINQ therefore is to run the individual actions serialized with respect to one another. This choice dramatically reduces the parallelism. However, the parallelism is not lost entirely, as individual query operations may still execute in parallel. We add a special ForAll library call which, when used, instructs the parallel LINQ system that it may execute individual processing actions entirely in parallel. The developer then chooses to write the body dependence-free or to synchronize the necessary parts of it.

The source changes introduced by the second observation are minor. For example, the following illustrates what a simple query might look like using the new ForAll API.

```
var results = from c in custs
        where ...
        select ...;
results.ForAll(delegate(var c) {
  Discount d = new Discount(...,
  c.TotalOrderCount * 5.00m);
  c.Discounts.Add(d);
});
```

The introduction of the ForAll operation thankfully changes the structure of the program in only very minor ways. A new language keyword is proposed—forall—which makes writing such loops even simpler:

```
forall (var c in results) {
  Discount d = new Discount(...,
    c.TotalOrderCount * 5.00m);
  c.Discounts.Add(d);
}
```

Using forall-style loops, while similar-looking to foreach loops, fundamentally impact the loop semantics—because it may execute out of order and in parallel—and thus serves as a visual aid to the developer. Serialization can be achieved using ordinary locking schemes, but obviously removes parallelism. Too much serialization can degrade performance to the point that it is not worth attempting parallel execution. In the most extreme case, the programmer could acquire a global critical section inside of each action, and hold it for the duration of the activity. The programmer is encouraged to use typical foreach statements in such cases.

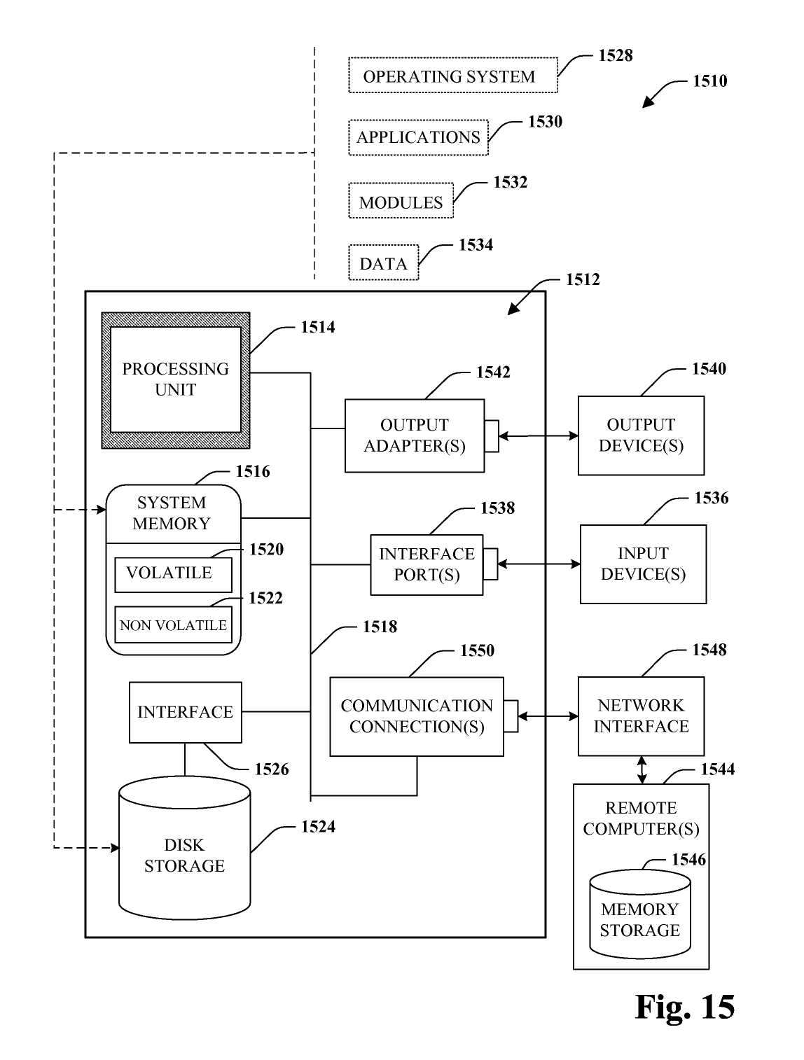

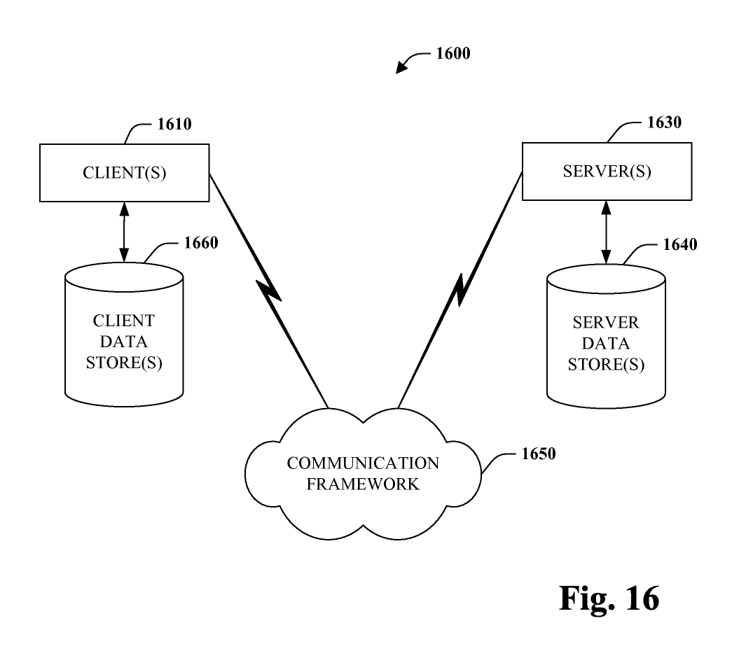

In order to provide a context for the various aspects of the disclosed subject matter, FIGS. 15 and 16 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 15, an exemplary environment 1510 for implementing various aspects disclosed herein includes a computer 1512 (e.g., desktop, laptop, server, hand held, programmable consumer or industrial electronics . . . ). The computer 1512 includes a processing unit 1514, a system memory 1516, and a system bus 1518. The system bus 1518 couples system components including, but not limited to, the system memory 1516 to the processing unit 1514. The processing unit 1514 can be any of various available microprocessors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/non-removable, volatile/non-volatile computer storage media. FIG. 15 illustrates, for example, disk storage 1524. Disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the present invention can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512 and to output information from computer 1512 to an output device 1540. Output adapter 1542 is provided to illustrate that there are some output devices 1540 like displays (e.g., flat panel and CRT), speakers, and printers, among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1516, it can also be external to computer 1512. The hardware/software necessary for connection to the network interface 1548 includes, for exemplary purposes only, internal and external technologies such as, modems including regular telephone grade modems, cable modems, power modems and DSL modems, ISDN adapters, and Ethernet cards or components.

FIG. 16 is a schematic block diagram of a sample-computing environment 1600 with which the subject innovation can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing the subject innovation, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A parallel software execution system comprising the following computer-implemented components:
a receiver component that receives one or more integrated program language collection operations; and
a plan component that supplies a plan for parallel execution of the one or more operations.

2. The system of claim 1, further comprises an execution engine that executes the plan to evaluate the one or more operations.

3. The system of claim 2, the plan component generates the plan based on static information that pertains to the one or more operations.

4. The system of claim 3, the one or more operators define a query within an object-oriented language.

5. The system of claim 4, the query is evaluated with respect to one or more heterogeneous data sources.

6. The system of claim 3, the plan generated by the plan component identifies parallel groupings of operations and associated parallelization strategy to optimize execution.

7. The system of claim 3, the plan is generated dynamically at runtime.

8. The system of claim 3, the plan component augments the plan at runtime based on dynamic context information including at least one of computer resources and utilization thereof.

9. The system of claim 8, further comprises an analysis component that analyzes the plan execution and provides the plan component with information that the plan component employs to modify the plan to improve subsequent execution performance.

10. A method of optimizing integrated language queries comprising the following computer implemented acts:
obtaining a language integrated query; and
executing a parallel execution plan to evaluate the query.

11. The method of claim 10, further comprising constructing the execution plan from static information including at least one of cost, selectivity, input and output categorization and ordering of operations that comprise the query.

12. The method of claim 11, constructing the execution plan at runtime.

13. The method of claim 11, constructing the plan by running the query through a separate planning utility that avoids runtime generation based solely on static information.

14. The method of claim 11, constructing the execution plan comprising identifying parallel operation groupings.

15. The method of claim 14, identifying parallel operation groupings comprises determining a set of contiguous operations without input requirements and the same ordering requirements.

16. The method of claim 14, further comprising determining the most efficient parallelization strategy including at least of inter and intra operator parallelism.

17. The method of claim 11, further comprising augmenting the execution plan to optimize parallelism based on dynamic information identified at runtime including at least one of machine topology, current utilization, dynamic context in which query is being used, size of input data and characteristics of the input data.

18. The method of claim 10, further comprising selecting an execution plan from a multitude of plans based on characteristics of an environment at runtime.

19. A method that facilitates parallel execution of integrated language queries comprising the following computer implemented acts:
receiving a language integrated query;
generating a plan for executing the query, the plan recording at least relative parallelism and flow of information between query operations;
augmenting the plan based on dynamic context information pertaining to at least one of the query, a data source and machine hardware; and
executing the query plan to produce query results.

20. The method of claim 19, further comprising analyzing execution and feeding back statistics into the query plan to be employed on future executions of the query.
